(19) United States
(12) Patent Application Publication
(10) Pub. No.: US 2024/0340532 A1
(43) Pub. Date: Oct. 10, 2024

(54) FOCUSING ADJUSTMENT METHOD

(71) Applicant: DENSO CORPORATION, Kariya-city (JP)

(72) Inventors: Ryohei OKAMOTO, Kariya-city (JP); Noboru KAWASAKI, Kariya-city (JP); Toshiki YASUE, Kariya-city (JP); Yasuki FURUTAKE, Kariya-city (JP); Hiroshi NAKAGAWA, Kariya-city (JP); Shunta SATO, Kariya-city (JP)

(21) Appl. No.: 18/749,380

(22) Filed: Jun. 20, 2024

Related U.S. Application Data
(63) Continuation of application No. PCT/JP2022/044528, filed on Dec. 2, 2022.

(30) Foreign Application Priority Data
Dec. 21, 2021 (JP) 2021-207023

(51) Int. Cl. H04N 23/67; H04N 23/55

(52) U.S. Cl. CPC H04N 23/67; H04N 23/55

(57) ABSTRACT

A focusing adjustment method of a camera module predicts, before completion of securing of a camera board to an optical system, a shrinkage deviation amount by which the optical system and the camera board will approach one another. The focusing adjustment method adjusts a position and an angle of the camera board to separate, by the predicted shrinkage deviation amount, the camera board from the optical system as compared with a focusing attitude of the image sensor with respect to the optical system where the optical system is in focus on the image sensor to accordingly offset the predicted shrinkage deviation amount.

### CROSS REFERENCE TO RELATED APPLICATION

The present application is a bypass continuation application of currently pending international application No. PCT/JP2022/044528 filed on Dec. 2, 2022 designating the United States of America, the entire disclosure of which is incorporated herein by reference, the internal application being based on and claiming the benefit of priority from Japanese Patent Application No. 2021-207023 filed on Dec. 21, 2021.

### TECHNICAL FIELD

The present disclosure relates to focusing adjustment methods.

### BACKGROUND

Each of many vehicles uses a plurality of camera modules installed therein, resulting in an increasing demand for camera modules. Such a camera module is comprised of mainly a CCD image sensor or a CMOS image sensor. In view of an increase in viewability of images captured by such a camera module, adjustment of a mount location of an image sensor with respect to a lens system is required to adjust the focus of the lens system to the image sensor.

Making a visual and manual adjustment of the mount location of the image sensor with respect to the lens system may result in variations in focusing accuracy. For this reason, automatic adjustment of the mount location of the image sensor with respect to the lens system has been frequently employed recently, examples of which are disclosed in Japanese Patent Application Publications No. 2002-267923, 2009-3152, and 2008-171866, respectively.

Each of the patent publications aims to reduce time required to adjust the focus of the lens system to the image sensor.

### SUMMARY

A process of fixedly mounting such a lens module to a camera board to which an image sensor is to be installed typically attaches the lens module to the camera board using thermosetting adhesive, and thereafter cures the thermosetting adhesive to thereby fixedly mount the lens module to the camera board.

During the process, components constituting the camera module may be heat-shrink or the adhesive may shrink due to its thermal curing. Curing the adhesive after adjustment of the image sensor with respect to the lens module may therefore result in the lens module and the image sensor being misalignment with one another, resulting in a reduction in the focusing accuracy.

In view of the circumstances set forth above, an aspect of the present disclosure seeks to provide focusing adjustment methods with higher focusing accuracy.

An exemplary aspect of the present disclosure provides a focusing adjustment method of a camera module that includes an optical system, an image sensor, and a camera board on which the image sensor is mounted. The focusing adjustment method includes the steps of thermally curing, after a position and an angle of the camera board with respect to the optical system is adjusted to match an actual attitude of the image sensor with a focusing attitude of the image sensor with respect to the optical system where the optical system is in focus on the image sensor and the camera board and the lens module are mounted on one another through an adhesive therebetween, the adhesive to accordingly secure the camera board to the optical system.

The focusing adjustment method includes predicting, between adjustment of the position and the angle of the camera board and completion of securing of the camera board to the optical system, a shrinkage deviation amount by which the optical system and the camera board will approach one another.

The focusing adjustment method includes adjusting the position and the angle of the camera board to separate, by the predicted shrinkage deviation amount, the camera board from the optical system as compared with the focusing attitude of the image sensor with respect to the optical system to accordingly offset the predicted shrinkage deviation amount.

The adjusting step adjusts the position and angle of the camera board to separate, by the predicted shrinkage deviation amount, the camera board from the optical system as compared with the focusing attitude of the image sensor with respect to the optical system where the optical system is in focus on the image sensor to accordingly offset the predicted shrinkage deviation amount.

That is, the focusing adjustment method according to the exemplary aspect adjusts the position and angle of the camera board to accordingly offset the predicted shrinkage deviation amount, making it possible to assemble the camera board to the optical system with higher focusing accuracy.

### BRIEF DESCRIPTION OF THE DRAWINGS

Other aspects of the present disclosure will become apparent from the following description of embodiments with reference to the accompanying drawings in which:

FIG. 1 is an exploded perspective view of a camera module;

FIG. 2 is a schematic view of the camera module;

FIG. 3 is a block diagram illustrating a focusing adjustment system;

FIG. 4 is a schematic view illustrating how a camera board is transferred;

FIG. 5 is a schematic view illustrating how the camera board is adjusted;

FIG. 6 is a schematic view illustrating how an image sensor captures an image of cross-shaped lights;

FIG. 7A is a schematic view illustrating the cross-shaped lights in an imaging area;

FIG. 7B is a schematic view illustrating the cross-shaped lights in a scan area;

FIG. 8 is a graph schematically illustrating an example of MTF curves;

FIG. 9 is a graph schematically illustrating a depth of focus of the camera module;

FIG. 10 is a graph schematically illustrating an example of MTF curves when the lens module is in focus on the image sensor;

FIG. 11 is a schematic view illustrating how laser beams are emitted to adhesive between the lens module and the camera board;

FIG. 12 is a flowchart schematically illustrating a focusing adjustment method;

FIGS. 13A, 13B, 13C, 13C1, 13D, and 13D1 schematically illustrate how the assembly of the lens module, the camera board, and the adhesive interposed therebetween thermally expands and thereafter thermally shrinks during preliminary curing of the assembly;

FIG. 14 is a flowchart schematically illustrating a prediction routine; and

FIG. 15 is a schematic view illustrating separation distances.

### DETAILED DESCRIPTION OF EMBODIMENT

The following describes an exemplary embodiment and its modification of focusing adjustment methods according to the present disclosure with reference to the accompanying drawings.

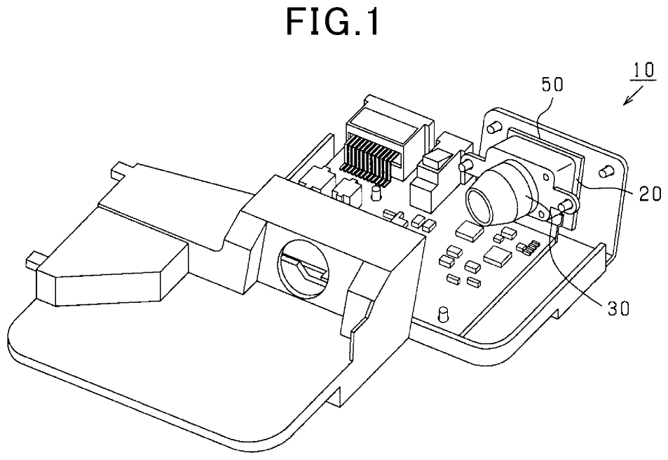

In the exemplary embodiment, the direction parallel to an optical axis of a lens module 30 is defined as a Z direction, a longitudinal direction of the lens module 30, which is a vertical direction in FIG. 1, perpendicular to the Z direction is defined as an X direction, and a lateral direction, which is a horizontal direction in FIG. 1, perpendicular to the Z direction is defined as a Y direction.

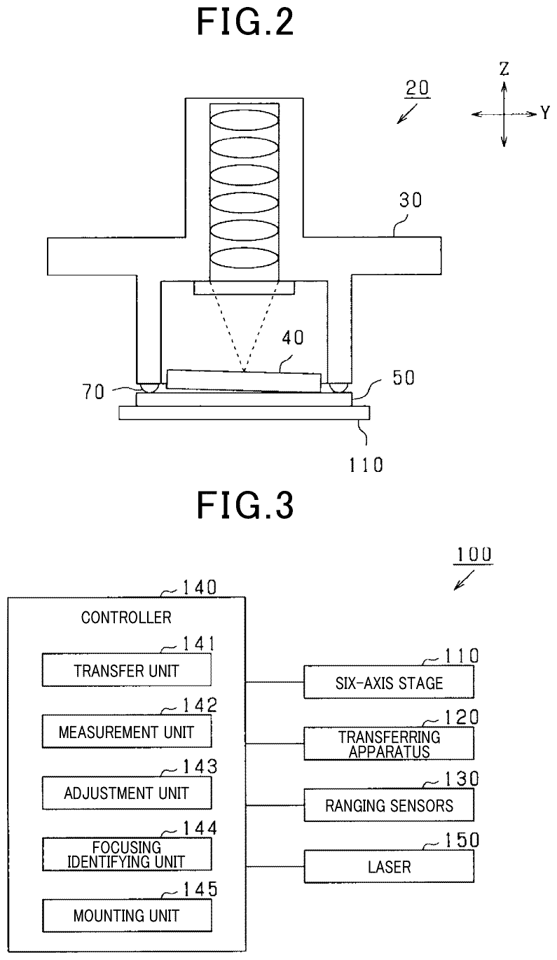

A camera device 10 illustrated in FIG. 1 includes a camera module installed therein. The camera module 20 includes, as illustrated in FIG. 2, the lens module 30 serving as an optical system, an image sensor 40, and a camera board 50 on which the image sensor 40 is mounted.

For example, a CMOS image sensor can be used as the image sensor 40, so that the camera module 20 can also be referred to as a CMOS camera module with a lens. Fixedly mounting the lens module 30 to the camera board 50 results in the camera module 20 being constructed.

The lens module 30 is secured to the camera board 50 through an adhesive, i.e., a thermosetting adhesive, 70.

Next, the following describes a focusing adjustment system 100. The focusing adjustment system 100 includes, as illustrated in FIG. 3, a six-axis stage 110 serving as a position adjustment device, a transferring apparatus 120, ranging sensors 130, a computer 140, and one or more laser devices 150 for emitting laser light.

The six-axis stage 110 includes a mechanism for adjusting the location and/or the inclination of the camera board 50. The six-axis stage 110 of the exemplary embodiment is configured to adjust positions of the camera board 50 in the respective three axes, i.e., the X-axis, Y-axis, and Z-axis, and adjust each of roll, yaw, pitch angles of the camera board 50 around a corresponding one of the three axes.

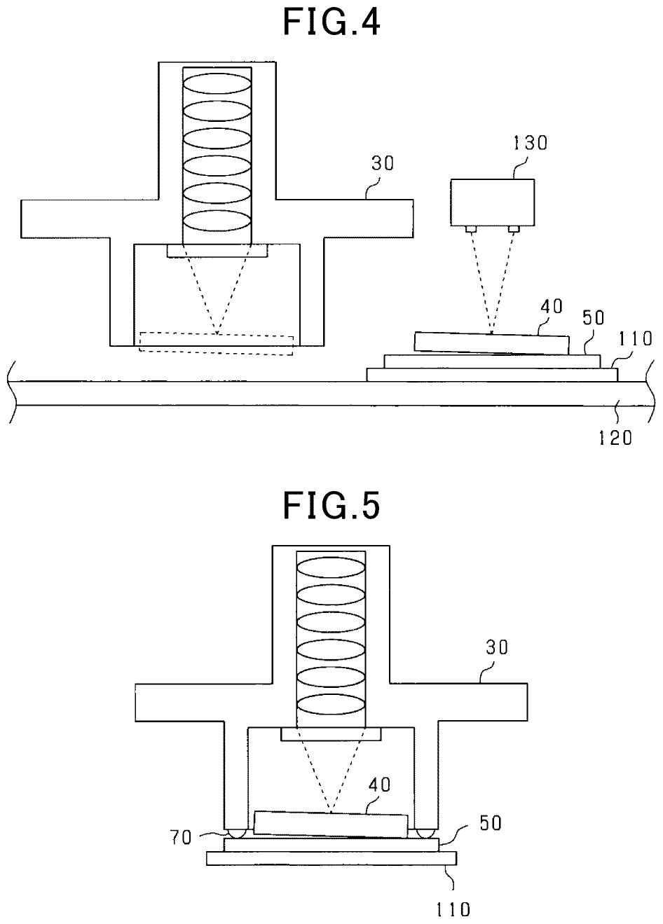

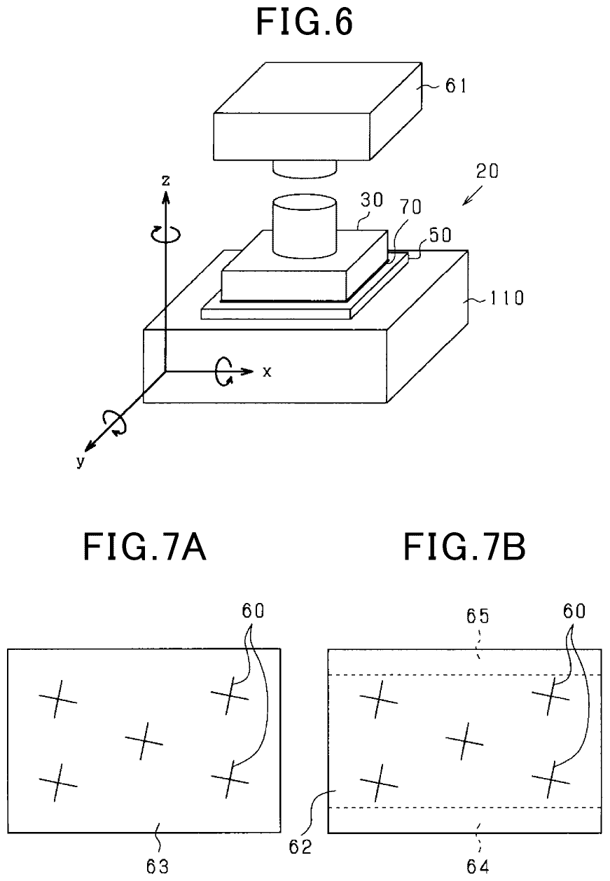

The transferring apparatus 120 is configured to transfer the six-axis stage 110 on which the camera board 50 is mounted. Specifically, the transferring apparatus 120 is configured to, as illustrated in FIG. 4, transfer the six-axis stage 60 on which the camera board 50 is mounted such that the image sensor 40 of the camera board 50 faces a set of lenses of the lens module 30.

The ranging sensors 130 are configured to measure mount locations and mount angles of the image sensor 40 during transferring of the camera board 50 by the transferring apparatus 120. Specifically, the image sensor 40 is fixedly mounted on the camera board 50 with, for example, adhesive or soldering. This therefore may be likely to deviate from a designed mount region of the camera board 50 due to the accuracy of mounting the image sensor 40 on the camera board 50. From this viewpoint, the ranging sensors 130 are configured to measure mount locations of the image sensor 40 in the X-, Y-, and Z-directions relative to respective previously designed reference locations in the X-, Y-, and Z-directions, and measure, as the mount angles, the roll, yaw, and pitch angles of the image sensor 40 relative to respectively corresponding previously designed reference angles.

The computer 140 includes a CPU, a RAM, a ROM, and other peripheral devices, and is configured to execute computer-program instructions stored in the ROM to accordingly implement various functions. The computer 140 further includes various input/output devices, and is configured to receive various instructions inputted through the input devices, and instruct various output devices to output various results computed thereby. Specifically, the computer 140 is, as illustrated in FIG. 3, configured to be connected to the six-axis stage 110, the transferring apparatus 120, the ranging sensors 130, and the laser devices 150, and is configured to receive various signals from the components 110, 120, 130, and 150, and output various signals to the components 110, 120, 130, and 150. These various signals can include, for example, instruction signals, each of which represents a corresponding instruction, and measurement-result signals, each of which represents a corresponding measurement result.

The computer 140 includes, as an example of the various functions, a transfer unit 141, a measurement unit 142, an adjustment unit 143, a focusing identifying unit 144, and a mounting unit 145. That is, the computer 140 serves as the transfer unit 141, measurement unit 142, adjustment unit 143, focusing identifying unit 144, and mounting unit 145. A single computer 140 can include all the functions 141 to 145, or plural computing apparatuses 140 can share the functions 141 to 145 with one another.

The computer 140 serves as the transfer unit 141 to control the transferring apparatus 120 to transfer the camera board 50 on the six-axis stage 110 until the image sensor 40 of the camera board 50 is arranged to face the set of the lenses of the lens module 30.

The computer 140 serves as the measurement unit 142 to control the ranging sensors 130 to measure the mount locations and the mount angles of the image sensor 40 during transferring of the camera board 50 by the transferring apparatus 120.

The computer 140 serves as the adjustment unit 143 to control the six-axis stage 6 to adjust the positions of the camera board 50 in the respective X, Y, and Z axes, and adjust each of the roll, yaw, pitch angles of the camera board 50. Specifically, as illustrated in FIG. 5, the adjustment unit 143 is configured to
(I) Adjust, based on the mount locations of the image sensor 40 on the camera board 50 in the X-, Y-, and Z-directions, the actual positions of the image sensor 40 relative to the lens module 30 in the X-, Y-, and Z-directions to respective typical optimum positions in the X-, Y-, and Z-directions
(II) Adjust, based on the mount angles, i.e., the mount roll, yaw, and pitch angles, of the image sensor 40, the actual angles, i.e., actual roll, yaw, and pitch angles, of the image sensor 40 relative to the lens module 30 to respective typical optimum angles, i.e., typical optimum roll, yaw, and pitch angles. The typical optimum positions of the image sensor relative to the lens module 30 will correspond to previously designed positions of the image sensor 40 relative to the lens module 30, and the typical optimum angles of the image sensor 40 relative to the lens module will correspond to previously designed angles of the image sensor 40 relative to the lens module 30.

The typical optimum positions and typical optimum angles of the image sensor 40 for the lens module 30 are determined such that, when the image sensor 40 is arranged to have the typical optimum positions and typical optimum angles relative to the lens module 30, the lens module 30 is in focus on the image sensor 40. The lens module 30 has the typical optimum positions and typical optimum angles for the image sensor 40, which were previously measured by a manufacturer of the lens module 30.

That is, the adjustment unit 143 is configured to adjust, based on deviations of the mount locations of the image sensor 40 on the camera board 50 in the X-, Y-, and Z-directions from the respective previously designed reference locations in the X-, Y-, and Z-directions, the actual positions of the image sensor 40 relative to the lens module 30 in the X-, Y-, and Z-directions to the respective typical optimum positions in the X-, Y-, and Z-directions. Additionally, the adjustment unit 143 is configured to adjust, based on deviations of the mount angles of the image sensor from the previously designed reference angle, the actual angles of the image sensor 40 relative to the lens module 30 to the respective typical optimum angles.

As the typical optimum position of the image sensor 40 relative to the lens module 30 in each of the X, Y, and Z directions, an average value of the measured optimum positions of the image sensor 40 relative to each of selected finished products of the lens module 30 in the corresponding one of the X, Y, and Z directions can be typically used. Similarly, as the typical optimum angle of the image sensor 40 relative to the lens module 30 around each of the X, Y, and Z directions, an average value of the measured optimum angles of the image sensor 40 relative to each of selected finished products of the lens module 30 around the corresponding one of the X, Y, and Z directions can be typically used. Alternatively, as the typical optimum position of the image sensor 40 relative to the lens module 30 in each of the X, Y, and Z directions, a calculated value based on, for example, the design drawings of the lens module 30 can be used, and as the typical optimum angle of the image sensor 40 relative to the lens module 30 around each of the X, Y, and Z directions, a calculated value based on, for example, the design drawings of the lens module 30 can be used.

For these reasons, the optimum position of a selected finished product of the lens module 30 in each of the X, Y, and Z directions may have a production error relative to the typical optimum position in the corresponding one of the X, Y, and Z directions, and the optimum angle of a selected finished product of the lens module 30 around each of the X, Y, and Z directions may have a production error relative to the typical optimum angle around the corresponding one of the X, Y, and Z directions.

That is, even if the actual position of the image sensor 40 relative to the lens module 30 in each of the X, Y, and Z directions and the actual angle of the image sensor 40 relative to the lens module 30 around each of the X, Y, and Z directions are respectively adjusted to the typical optimum position and the typical optimum angle thereof, the lens module may be out of focus on the image sensor 40.

From this viewpoint, the computer 140 serves as the focusing identifying unit 144 to cause the image sensor 40 to capture chart images through the lens module 30, and analyze captured image data of the chart images to accordingly identify a focusing attitude of the image sensor 40 with respect to the lens module 30 where the lens module 30 is in focus on the image sensor 40.

The following describes in detail how the focusing identifying unit 144 identifies the focusing attitude of the image sensor 40 with respect to the lens module 30 where the lens module 30 is in focus on the image sensor 40.

An optical source 61 covered with a sheet, such as a black paper, having plural cross-shaped slits is prepared; each cross-shaped slit is comprised of a longitudinal (X-directional) slit closer to the X direction and a lateral (Y-directional) slit closer to the Y-direction that intersect with one another.

Light emitted from the optical source 61 through the sheet is irradiated onto the camera module 20, so that, as illustrated in FIG. 7A, cross-shaped lights 60 are generated as the chart images. Specifically, the cross-shaped slits of the sheet cause light passing therethrough to become the cross-shaped lights, i.e., cross slit lights, 60 that respectively serve as the chart images. The cross-shaped lights 60 are separated from one another, so that the cross-shaped lights 60 are arranged at respective predetermined positions on a substantially rectangular imaging area 63 of the image sensor 40 of the camera module 20. For example, FIG. 7A shows that the cross-shaped lights 60 are respectively arranged at the center, the upper right, the lower right, the upper left, and the lower left of the imaging area 63.

The computer 140 serves as the focusing identifying unit 144 cause the image sensor 40 to capture the cross-shaped lights 60 through the lens module 30, and analyze captured image data of the cross-shaped lights 60 to accordingly calculate a Modulation Transfer Function (MTF) curve of each cross-shaped light 60. The MTF curve of each chart image, i.e., each cross-shaped light 60, is one of performance metrics of a lens, and reflects how the lens reproduces contrast of each chart image, i.e., each cross-shaped light 60, as a function of spatial frequency.

Specifically, each time the camera board 50 is scanned by the six-axis stage 110 in a predetermined scan region in, for example, the Z direction so that the image sensor 40 is located at a corresponding one of previously selected positions in the Z axis, the computer 140 causes the image sensor 40 to capture the cross-shaped lights 60, and analyzes the captured image-data items of each cross-shaped light 60 at the respective Z-axis positions to accordingly calculate
(1) MTF values (%) of the longitudinal (X-directional) slits of the respective cross-shaped lights 60 at each of the Z-axis positions
(2) MTF values (%) of the lateral (Y-directional) slits of the respective cross-shaped lights 60 at each of the Z-axis positions

For example, assuming that the number of cross-shaped lights 60 is five, ten MTF values of the longitudinal and lateral slits of the respective cross-shaped lights 60 at each of the Z-axis positions are calculated.

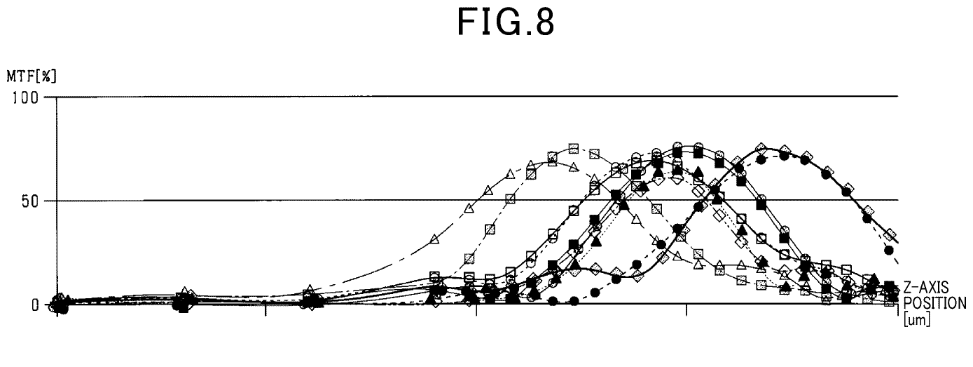

Then, the computer 140 plots the calculated MTF values in vertical and horizontal axes of coordinate; the vertical axis represents the MTF values for each slit of the cross-sectional lights 60, and the horizontal axis represents the Z-axis positions. Next, the computer 140 connects the MTF values for each slit of the cross-sectional lights 60 to one another to accordingly calculate a MTF curve for each slit of the cross-sectional lights 60. Because the total number of longitudinal and lateral slits of the cross-sectional lights 60 is ten so that ten MTF values of the longitudinal and lateral slits of the respective cross-shaped lights 60 at each of the Z-axis positions are calculated, the computer 140 calculates, as illustrated in FIG. 8, the total ten MTF curves.

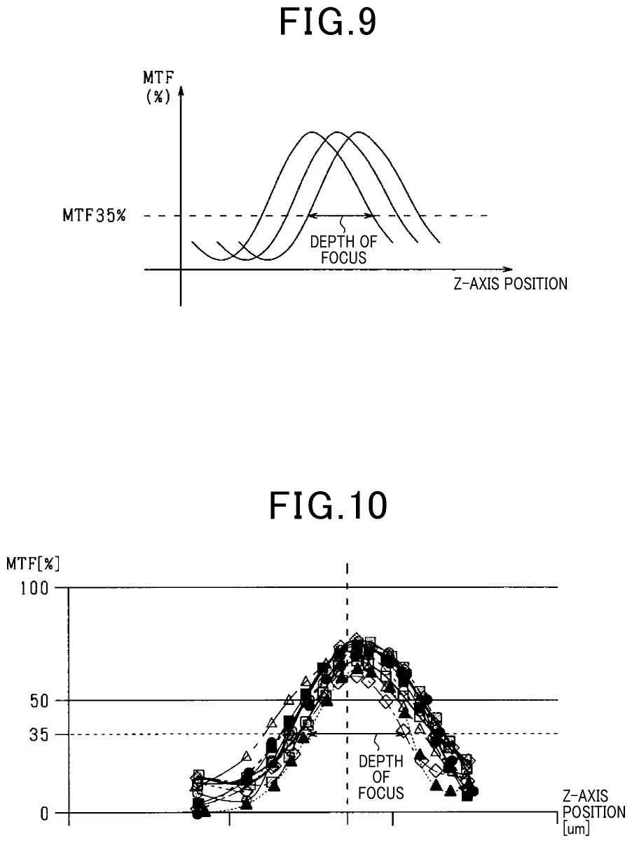

After calculation of the ten MTF curves, the computer 140 is configured to calculate, as illustrated in FIG. 9, a corrected value of the position of the image sensor 40 in each of the X, Y, and Z directions, and a corrected value of each of the roll, yaw, and pitch angles of the image sensor 40 around the corresponding one of the X, Y, and Z directions such that a depth of focus of the camera module 20 at a predetermined reference MTF value of, for example, 35%, becomes maximum.

Specifically, as illustrated in FIG. 9, the computer 140 moves the MTF curves to close to one another such that a distance corresponding to the depth of focus at the MTF value of 35% becomes maximum. Then, the computer 140 calculates, when the depth of focus becomes maximum, a value of movement of each of the MTF curves in the Z direction, and calculates, based on the value of movement of each of the MTF curves, the corrected value of the position of the image sensor 40 in each of the X, Y, and Z directions, and the corrected value of each of the roll, yaw, and pitch angles of the image sensor 40 around the corresponding one of the X, Y, and Z directions.

On the basis of the calculated corrected values of the positions and angles of the image sensor 40, the computer 140 identifies the focusing attitude of the image sensor 40 with respect to the lens module 30 where the lens module 30 is in focus on the image sensor 40. Then, the computer 140 controls the six-axis stage 110 to adjust the actual positions and actual angles of the camera board 50 such that an actual attitude of the image sensor 40 matches the identified focusing attitude.

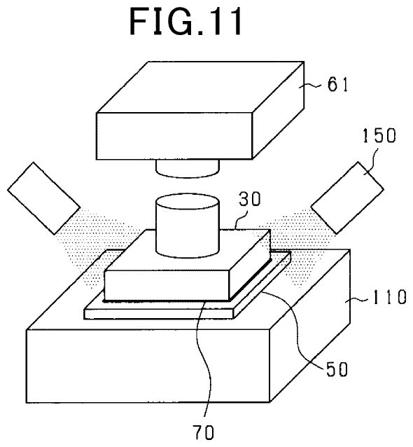

Ather the actual mount attitude of the image sensor 40 matches the identified focusing attitude, the computer 140 serves as the mounting unit 145 to control each of the laser devices 150 to irradiate, as illustrated in FIG. 11, the adhesive 70 previously applied onto the camera board 50 with a laser beam. That is, while the lens module 30 and the camera board 50 are mounted onto one another with the adhesive 70 therebetween, the computer 140 controls each laser device 150 to irradiate the adhesive 70 with a laser beam to accordingly heat the adhesive 70. This results in the adhesive 70 being temporarily being cured, so that the camera board 50 is mounted to the lens module 30.

As described above, each time the image sensor 40 is located at a corresponding one of the previously selected different positions in the Z axis, the computer 140 causes the image sensor 40 to capture each cross-shaped light 60 in order to calculate the MTF curves. This therefore requires movement of the camera board 50 in the Z direction and stop movement of the camera board 50 at each of the selected different positions in the Z direction. This may result in vibrations of the camera board 50 each time the camera board 50 stops after movement. Vibrations of the camera board 50 including the image sensor 40 would cause an error in chart images captured by the image sensor 40. For this reason, it may be necessary to establish, each time movement of the camera board 50 is stopped, a wait time until vibrations of the camera board 50 are sufficiently suppressed. This may result in an increase in the time of adjusting the focus of the camera module 20.

From this viewpoint, the exemplary embodiment puts the following first to fourth devices in order to reduce the time of adjusting the focus of the camera module 20.

The first device is that the computer 140 is configured to control the six-axis stage 110 to move the camera board 50 in the predetermined scan region in the Z direction; the scan region in the Z direction is previously defined relative to the optimum positions and optimum angles of the image sensor 40. For example, the scan region is defined to have a center corresponding to the optimum position in the Z direction.

The second device is that the computer 140 causes the image sensor 40 to capture the cross-shaped lights 60 while continuously moving the camera board 50 without being stopped in the predetermined scan region, and analyze the captured image-data items of each cross-shaped light 60 at the respective Z-axis positions. For example, the computer 140 can cause the image sensor 40 to capture the cross-shaped lights 60 while continuously moving, at a constant speed, the camera board 50 without being stopped in the predetermined scan region.

The third device is that a time, i.e., a light exposure time, during which the image sensor 40 is exposed to light for capturing of one frame image that includes the cross-shaped lights, i.e., the chart images, 60 becomes shorter down to the limit at which the captured chart images can be recognized. That is, because the image sensor 40 captures the cross-shaped lights 60, the light exposure time during which the image sensor captures one frame image can be shorter as compared with a case where the image sensor 40 captures a frame image of chart images printed on a paper. For example, the light exposure time can be set to be shorter than a typical light exposure time of 33.3 ms or 16.7 ms, such as can be set to 0.7 ms.

The fourth device is that, although the image sensor 40 is typically configured to capture a frame image of the imaging area 63, the image sensor 40 is modified to capture a frame image of a scan area 62 smaller in size than the imaging area 63. Specifically, because the cross-shaped lights 60 are respectively arranged at predetermined positions in the imaging area 63, the scan area 62 can be defined such that the image sensor 40 does not capture an image of portions of the imaging area 63; the portions do not include the cross-shaped lights 60. For example, as illustrated in FIG. 7B, a lower edge portion 64 and an upper edge portion 65 of the imaging area 63, where no cross-shaped lights 60 are located, are eliminated from the imaging area 63, so that the scan area 62 is created.

If a width of the imaging area 63 in the longitudinal direction, i.e., the X direction, is set to a length corresponding to 1876 pixels, a width of the scan area 62 in the longitudinal direction, i.e., the X direction, can be set to a length corresponding to 1369 pixels. It is desirable that the size of the scan area 62 is determined to reliably capture the cross-shaped lights 60 with an error.

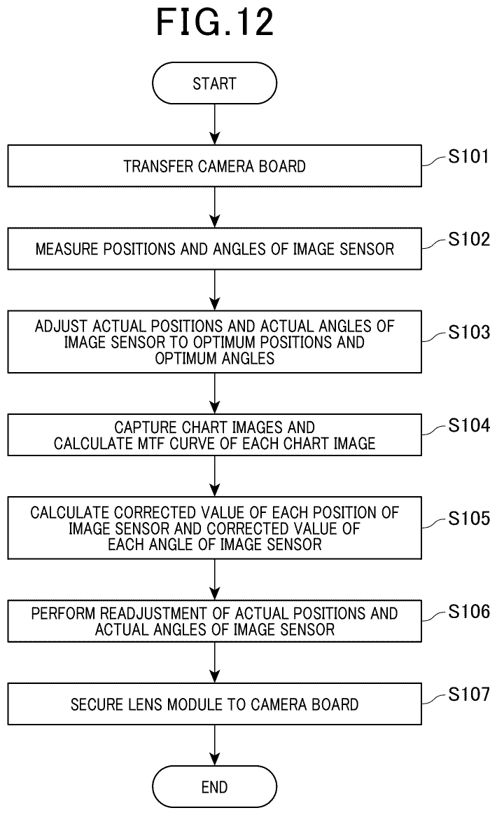

Next, the following describes a focusing adjustment method with reference to FIG. 12, which can be carried out by the computer 140.

The computer 140 serves as the transfer unit 141 to perform a transferring step of starting, after the camera board 50 is mounted on the transferring apparatus 120, controlling of the transferring apparatus 120 to transfer the camera board 50 on the six-axis stage 110 until the image sensor 40 of the camera board 50 is arranged to face the lens module 30 in step S101. On the camera board 50 to be transferred in step S101, the adhesive 70 for bonding of the lens module 30 to the camera board 50 has been already applied to the camera board 50. In step S101, the camera board 50 with no adhesive can be transferred as long as the adhesive 70 is scheduled to be applied to the camera board 50 in a later step, such as step S107.

Next, the computer 140 serves as the measurement unit 142 to perform a measurement step of controlling the ranging sensors 130 to measure the mount locations and the mount angles of the image sensor on the camera board 50 during transferring of the camera board 50 by the transferring apparatus 120 in step S102.

Following the operation in step S102, after the image sensor 40 reaches a location where the image sensor 40 faces the lens module 30, the computer 140 serves as the adjustment unit 143 to control the six-axis stage 6 to adjust the positions of the camera board 50 in the respective X, Y, and Z axes, and adjust each of the roll, yaw, pitch angles of the camera board 50 in step S103.

Specifically, in step S103, the computer 140 serves as the adjustment unit 143 to
(I) Adjust, based on the mount locations of the image sensor 40 on the camera board 50 in the X-, Y-, and Z-directions, the actual positions of the image sensor 40 relative to the lens module 30 in the X-, Y-, and Z-directions to the respective typical optimum positions in the X-, Y-, and Z-directions
(II) Adjust, based on the mount angles, i.e., the mount roll, yaw, and pitch angles, of the image sensor 40, the actual angles, i.e., actual roll, yaw, and pitch angles, of the image sensor 40 relative to the lens module 30 to the respective typical optimum angles, i.e., typical optimum roll, yaw, and pitch angles

Following the operation in step S103, the computer 140 serves as the focusing identifying unit 144 to cause the image sensor 40 to capture the cross-shaped lights 60 as the chart images through the lens module 30, and analyze captured image data of the cross-shaped lights 60 to accordingly calculate the MTF curve of each cross-shaped light 60 in step S104.

Specifically, in step S104, the computer 140 for example causes the image sensor 40 to capture, during a shorter light exposure time per frame, frame images of the cross-shaped lights 60 while continuously moving, at a constant speed, the camera board 50 in the scan region that is previously defined relative to the optimum positions and optimum angles of the image sensor 40; the shorter light exposure time per frame results in a higher frame rate.

In step S104, the computer 140 analyzes the image data of the cross-shaped lights 60 to calculate the MTF curve of each cross-shaped light 60 in parallel to capturing the image data of the cross-shaped lights 60. Alternatively, in step S104, after completion of acquiring the image data of the cross-shaped lights 60 at all the selected different positions in the Z direction, the computer 140 can analyze the image data of the cross-shaped lights 60 at all the selected different positions in the Z direction to calculate the MTF curve of each cross-shaped light 60.

Additionally, in step S105, the computer 140 serves as focusing identifying unit 144 to calculate, after calculation of the MTF curves of the respective cross-shaped lights 60, a corrected value of the position of the image sensor 40 in each of the X, Y, and Z directions, and a corrected value of each of the roll, yaw, and pitch angles of the image sensor 40 around the corresponding one of the X, Y, and Z directions such that the depth of focus of the camera module 20 at a predetermined reference MTF value becomes maximum.

The operations in steps S103 and S104 serve as a focusing identifying step.

Following the operation in step S104, the computer 140 controls the six-axis stage 110 to adjust, again, the actual positions and actual angles of the camera board 50 based on the calculated corrected values of the positions and angles of the image sensor 40 such that an actual attitude of the image sensor 40 matches an identified focusing attitude with respect to the lens module 30 where the lens module 30 is in focus on the image sensor 40 in step S106. Each of the operation in step S103 and the operation in step S106 serves as an adjustment step. That is, the method can perform one or more adjustment steps if need arises.

Following the operation in step S106, the computer 140 serves as the mounting unit 145 to perform a mount step of controlling each of the laser devices 150 to irradiate the adhesive 70 previously applied between the camera board 50 and the lens module 30 with a laser beam to temporarily cure the adhesive 70 in step S107. That is, while the lens module 30 and the camera board 50 are mounted onto one another with the adhesive 70 therebetween, the computer 140 controls each laser device 150 to irradiate the adhesive 70 with a laser beam to accordingly heat the adhesive 70, resulting in the adhesive 70 being temporarily being cured. Thereafter, the assembly of the camera board 50 and the lens module 30 is stored in a thermostatic chamber, resulting in the adhesive 70 being completely cured. This results in the lens module 30 being reliably secured to the camera board 50, making it possible to complete the camera module 20.

After adjustment of a positional relationship between the lens module 30 and the camera board 50 in step S106, the computer 140 serves as the mounting unit 145 to perform the mount step of controlling each of the laser devices 150 to irradiate the adhesive 70 previously applied between the camera board 50 and the lens module 30 with the laser beam to preliminarily cure the adhesive 70 in step S107. Until preliminary curing of the adhesive 70 is completed after the adjustment in step S106, an actual positional relationship between the lens module and the camera board 20 may deviate from the adjusted positional relationship between the lens module 30 and the camera board 50.

The following describes in detail the deviation.

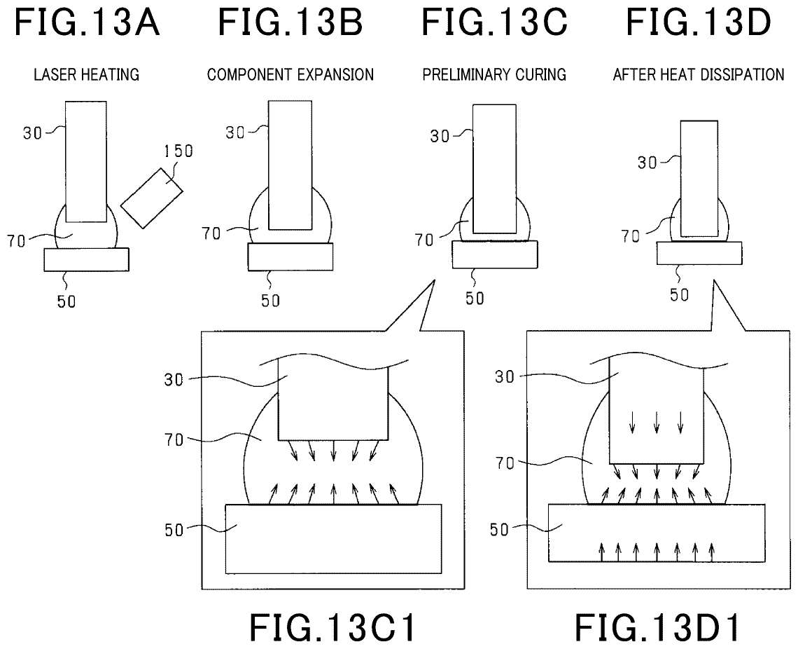

Irradiation of the adhesive 70 with a laser beam from each laser device 150 (see FIG. 13A) results in, as illustrated in FIG. 13B, the adhesive 70, the lens module 30, and the camera board 50 thermally expanding due to heat. Preliminary curing of the adhesive 70 thereafter may cause, as illustrated in FIG. 13C, a surface of the lens module 30, which is in contact with the adhesive 70, to be adhered to the adhesive 70, and a surface of the camera board 50 which is in contact with the adhesive 70, to be adhered to the adhesive 70. At that time, as illustrated in FIG. 13C1, which is an enlarged view of FIG. 13C, while a first surface of the adhesive 70, which is in contact with the lens module 30, is adhered to the lens module 30 and a second surface of the adhesive 70, which is in contact with the camera module 50, is adhered to the camera module 50, the adhesive 70 is cured to shrink. This cure shrinkage of the adhesive 70 may pull, as illustrated in FIG. 13C1, both the lens module 30 and the camera board 50 to be close to one another.

Thereafter, heat dissipation from the adhesive 70, lens module 30, and camera board 50 may cause, as illustrated in FIG. 13D1 which is an enlarged view of FIG. 13D, an expanding portion of each of the lens module 30, camera board 50, and the adhesive 70 to shrink. This may pull both the lens module 30 and the camera board 50 to be further close to one another by the shrinkage of expanding portion of each of the lens module 30, camera board 50, and the adhesive 70.

Accordingly, until preliminary curing of the adhesive 70 is completed after the adjustment in step S106, the actual positional relationship between the lens module 30 and the camera board 20 may deviate from the adjusted positional relationship between the lens module and the camera board 50. Additionally, heat by the laser beam may cause warpage of the camera board 50 to occur, resulting in the actual positional relationship between the lens module 30 and the camera board deviating from the adjusted positional relationship between the lens module 30 and the camera board 50.

From this viewpoint, the focusing adjustment method according to the exemplary embodiment predicts these deviations, and adjusts, in step S106, the actual positions and actual angles of the camera board 50 while offsetting the predicted deviations. This aims to prevent, as much as possible, deviations of the actual positional relationship between the lens module 30 and the camera board 50 from the adjusted positional relationship therebetween at the completion of the preliminary curing of the adhesive 70.

Let us assume that a distance, i.e., a shrinkage distance or a shrinkage deviation, in the Z direction by which the lens module 30 and the camera board 50 will approach one another during a period from completion of the readjustment process in step S106 to completion of the preliminary curing of the adhesive 70 will be referred to merely as a shrinkage distance E100.

First, the following describes how the computer 140 predicts the shrinkage distance E100.

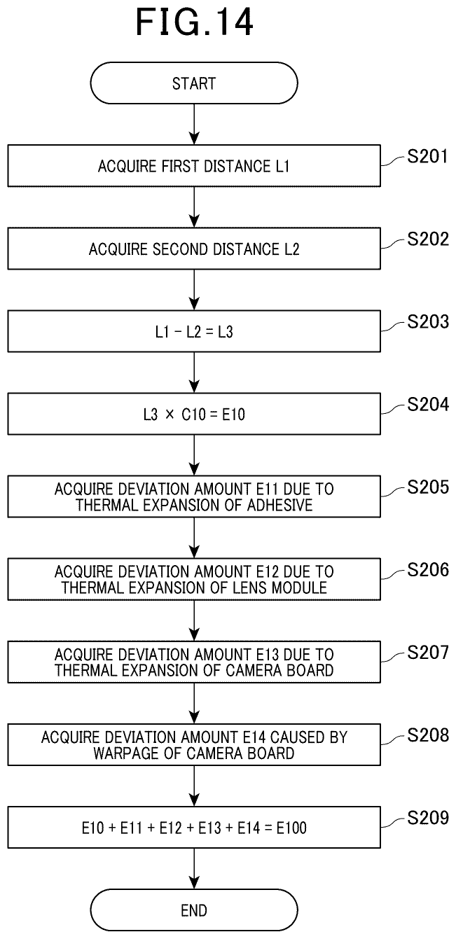

The computer 140 performs a prediction routine illustrated in FIG. 14 after the operation in step S105 and before the operation in step S106.

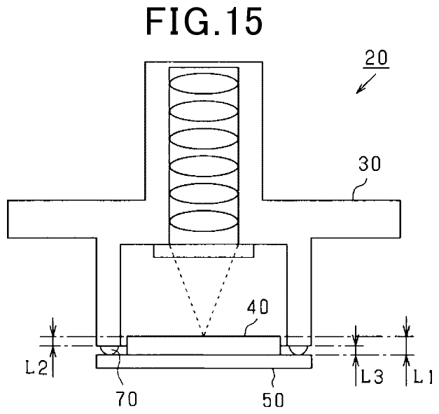

The computer 140 acquires a first distance L1 between a major surface of the image sensor 40, which faces the lens module 30 and will be referred to as a facing major surface, and a major surface of the camera board 50, which faces the lens module 30 and will be referred to as a facing major surface, in the Z direction in step S201 (see FIG. 15). For example, the computer 140 can calculate the first distance L1 in accordance with the mount locations and the mount angles of the image sensor 40 measured in step S102.

The image sensor 40, which has a rectangular shape, may be mounted on the camera board 50 while being tilted with respect to the camera board 50. The first distance L1 may vary depending on a selected position of the major surface of the camera board 50; the selected position is a basis for measurement of the first distance L1. Because such a variation is very small, the computer 140 identifies the first distance L1 using any position of the facing major surface of the camera board 50. The computer 140 of the exemplary embodiment identifies, as the first distance L1, a distance between a center of the facing major surface of the image sensor 40 and a center of the facing major surface of the camera board 50 in the Z direction.

Next, the computer 140 acquires a second distance L2 between the facing major surface of the image sensor 40 and a surface, which will be referred to as an adhered surface, of the lens module 30 being in contact with the adhesive 70 in the Z direction in step S202 (see FIG. 15).

The lens module 30 has, as the adhered surface, an end face, which faces the camera board 50 and has a rectangular frame shape with four sides and four corners. The four sides of the adhered surface of the lens module 30 are adhered to the facing major surface of the camera board 50 with the adhesive 70 therebetween while surrounding the rectangular image sensor 40. If the camera board 50 is tilted with respect to the lens module 30 for adjustment of the focus of the lens module 30 to the image sensor 40, the second distance L2 may vary depending on a selected position of the four sides and four corners of the adhered surface of the lens module 30; the selected position is a basis for measurement of the second distance L2.

Because such a variation is very small, the computer 140 identifies the second distance L2 using any position of the four sides and four corners of the adhered surface of the lens module 30. The computer 140 of the exemplary embodiment identifies, as the second distance L2, a distance between any corner of the adhered surface of the lens module and the center of the facing major surface of the image sensor 40 in the Z direction.

Because the image sensor 40 is arranged at the optimum positions and the optimum angles, the computer 140 can identify the second distance L2 based on (i) the optimum positions and the optimum angles of the image sensor 40 and (ii) the shape, i.e., the designed dimensions, of the lens module 30. As another example, the second distance L2 can be measured by, for example, a sensor.

Following the operation in step S202, the computer 140 calculates an absolute difference between the first distance L1 and the second distance L2 to accordingly acquire a separation distance L3 (see FIG. 15) from the lens module 30 to the camera board 50 in the Z direction in step S203.

Next, the computer 140 multiplies the separation distance L3 by a coefficient C10 that is previously determined based on the physical properties of the adhesive 70 to accordingly calculate a deviation amount E10 in step S204. Specifically, experiments showed that a distance by which the camera board 50 and the lens module 30 approach one another due to cure shrinkage of the adhesive 70 increase to be proportional to the separation distance L3. Experiments additionally showed that the coefficient C10 of the adhesive 70 varies depending on the physical properties of the adhesive 70.

In accordance with the results of the experiments, the computer 140 of the exemplary embodiment is configured to multiply the separation distance L3 by the coefficient C10 that is previously determined based on the physical properties of the adhesive 70 to accordingly calculate the deviation amount E10 due to the cure shrinkage of the adhesive 70. The coefficient C10 based on the physical properties of the adhesive 70 can be identified by, for example, experiments.

Next, the computer 140 acquires a deviation amount E11 due to (i) thermal expansion of the adhesive 70 and (ii) shrinkage of the adhesive 70 based on heat dissipation in step S205. The deviation amount E11 due to (i) thermal expansion of the adhesive 70 and (ii) shrinkage of the adhesive 70 based on heat dissipation will also be referred to as a deviation amount E11 due to thermal expansion of the adhesive 70. Specifically, experiments showed that the deviation amount E11 due to thermal expansion of the adhesive 70 increases in proportional to an increase in temperature of the adhesive 70 induced by laser-beam irradiation thereon. Experiments additionally showed that a proportionality coefficient C11 of this proportional increase varies depending on (i) the configuration of the adhesive 70, such as the thickness of the adhesive 70 in the Z direction and the amount of the adhesive 70, and/or (ii) the physical properties of the adhesive 70.

In accordance with the results of the experiments, the computer 140 of the exemplary embodiment is configured to multiply the increase in temperature of the adhesive 70 by the coefficient C11 based on the configuration of the adhesive 70 and/or (ii) the physical properties of the adhesive 70 to accordingly calculate the deviation amount E11 due to thermal expansion of the adhesive 70.

Because the increase in temperature of the adhesive 70 induced by laser-beam irradiation thereon is a substantially constant value, the increase in temperature of the adhesive 70 induced by laser-beam irradiation thereon can be identified by experiments. Similarly, because there is little variation in the configuration and the physical properties of the adhesive 70, the coefficient C11 can also be identified by experiments. For these reasons, the increase in temperature of the adhesive 70 and the coefficient C11 can be stored in a storage device, and the computer 140 can retrieve, from the storage device, the increase in temperature of the adhesive 70 and the coefficient C11 from the storage device, and calculate the deviation amount E11 based on the increase in temperature of the adhesive 70 and the coefficient C11 retrieved from the storage device in step S205.

Similarly, because the deviation amount E11 due to thermal expansion of the adhesive 70 can be substantially constant, the deviation amount E11 can be identified by experiments. For this reason, the deviation amount E11 can be stored in the storage device, and the computer 140 can retrieve, from the storage device, the deviation amount E11 in step S205. For example, the deviation amount E11 is stored previously in the storage device.

Next, the computer 140 acquires a deviation amount E12 due to (i) thermal expansion of the lens module 30 and (ii) shrinkage of the lens module 30 based on heat dissipation in step S206. The deviation amount E12 due to (i) thermal expansion of the lens module 30 and (ii) shrinkage of the lens module 30 based on heat dissipation will also be referred to as a deviation amount E12 due to thermal expansion of the lens module 30. Specifically, experiments showed that the deviation amount E12 due to thermal expansion of the lens module 30 increases to be proportional to an increase in temperature of the lens module 30 induced by laser-beam irradiation thereon. Experiments additionally showed that a proportionality coefficient C12 of this proportional increase varies depending on (i) the configuration of the lens module 30, such as the size or shape of the lens module 30 and/or (ii) the quality of materials of the lens module 30.

In accordance with the results of the experiments, the computer 140 of the exemplary embodiment is configured to multiply the increase in temperature of the lens module 30 by the coefficient C12 based on the configuration of the lens module 30 and/or (ii) the quality of materials of the lens module 30 to accordingly calculate the deviation amount E12 due to thermal expansion of the lens module 30.

Because the increase in temperature of the lens module 30 induced by laser-beam irradiation thereon is a substantially constant value, the increase in temperature of the lens module 30 induced by laser-beam irradiation thereon can be identified by experiments. Similarly, because there is little variation in the configuration and the quality of materials of the lens module 30, the coefficient C12 can also be identified by experiments. For these reasons, the increase in temperature of the lens module 30 and the coefficient C12 can be stored in the storage device, and the computer 140 can retrieve, from the storage device, the increase in temperature of the lens module 30 and the coefficient C12 from the storage device, and calculate the deviation amount E12 based on the increase in temperature of the lens module 30 and the coefficient C12 retrieved from the storage device in step S206.

Similarly, because the deviation amount E12 due to thermal expansion of the lens module 30 can be substantially constant, the deviation amount E12 can be identified by experiments. For this reason, the deviation amount E12 can be stored in the storage device, and the computer 140 can retrieve, from the storage device, the deviation amount E12 in step S206. For example, the deviation amount E12 is stored previously in the storage device.

Next, the computer 140 acquires a deviation amount E13 due to (i) thermal expansion of the camera board 50 and (ii) shrinkage of the camera board 50 based on heat dissipation in step S207. The deviation amount E13 due to (i) thermal expansion of the camera board 50 and (ii) shrinkage of the camera board 50 based on heat dissipation will also be referred to as a deviation amount E13 due to thermal expansion of the camera board 50. Specifically, experiments showed that the deviation amount E13 due to thermal expansion of the camera board 50 increases to be proportional to an increase in temperature of the camera board 50 induced by laser-beam irradiation thereon. Experiments additionally showed that a proportionality coefficient C13 of this proportional increase varies depending on (i) the configuration of the camera board 50, such as the size or shape of the camera board 50 and/or (ii) the quality of materials of the camera board 50.

In accordance with the results of the experiments, the computer 140 of the exemplary embodiment is configured to multiply the increase in temperature of the camera board 50 by the coefficient C13 based on the configuration of the camera board 50 and/or (ii) the quality of materials of the camera board 50 to accordingly calculate the deviation amount E13 due to thermal expansion of the camera board 50.

Because the increase in temperature of the camera board 50 induced by laser-beam irradiation thereon is a substantially constant value, the increase in temperature of the camera board 50 induced by laser-beam irradiation thereon can be identified by experiments. Similarly, because there is little variation in the configuration and the quality of materials of the camera board 50, the coefficient C13 can also be identified by experiments. For these reasons, the increase in temperature of the camera board 50 and the coefficient C13 can be stored in the storage device, and the computer 140 can retrieve, from the storage device, the increase in temperature of the camera board 50 and the coefficient C13 from the storage device, and calculate the deviation amount E13 based on the increase in temperature of the camera board 50 and the coefficient C13 retrieved from the storage device in step S207.

Similarly, because the deviation amount E13 due to thermal expansion of the camera board 50 can be substantially constant, the deviation amount E13 can be identified by experiments. For this reason, the deviation amount E13 can be stored in the storage device, and the computer 140 can retrieve, from the storage device, the deviation amount E13 in step S207. For example, the deviation amount E13 is stored previously in the storage device

Next, the computer 140 acquires a deviation amount E14 caused by heat warpage of the camera board 50 due to an increase in temperature of the camera board 50 induced by laser-beam irradiation thereon in step S208. The deviation amount E14 caused by heat warpage of the camera board 50 due to an increase in temperature of the camera board 50 induced by laser-beam irradiation thereon is substantially a constant value as long as there is little variation in the configuration and the quality of materials of the camera board 50, so that the deviation amount E14 can be identified by, for example, experiments, and stored in the storage device. In step S208, the computer 140 of the exemplary embodiment can retrieve, from the storage device, the deviation amount E14.

Following the operation in step S208, the computer 140 calculates the sum of the deviation amount E10 acquired in step S204, the deviation amount E11 acquired in step S205, the deviation amount E12 acquired in step S206, the deviation amount E13 acquired in step S207, and the deviation amount E14 acquired in step S208 to accordingly predict the shrinkage distance E100 in step S209. Thereafter, the computer 140 terminates the prediction routine. The above operations in steps S201 to S209 correspond to a prediction step.

After the readjustment process in step S106, the computer 140 performs an offset task of controlling, in step S106, the six-axis stage 110 to adjust the position of the camera board 50 in the Z axis such that the distance between the lens module 30 and the camera board 50 in the Z direction becomes greater by the predicted shrinkage distance E100. That is, the computer 140 controls the six-axis stage 110 to separate, from the lens module 30, the camera board 50 by the predicted shrinkage distance E100 in the Z direction relative to the identified focusing attitude of the camera board 50 to accordingly offset the camera board 50 by the predicted shrinkage distance E100 in the Z direction in step S106. In step S106, the computer 140 can reflect the predicted shrinkage distance E100 on the corrected value of the position of the image sensor 40 in the Z direction to accordingly offset the camera board 50 by the predicted shrinkage distance E100 in the Z direction in step S106.

The following describes advantageous benefits achieved by the focusing adjustment method according to the exemplary embodiment.

The computer 140 measures, in step S102, the mount locations and the mount angles of the image sensor 40 on the camera board 50.

In step S103, the computer 140 performs
(I) An adjustment of, based on the mount locations of the image sensor 40 on the camera board 50 in the X-, Y-, and Z-directions, the actual positions of the image sensor 40 relative to the lens module 30 in the X-, Y-, and Z-directions to the respective typical optimum positions in the X-, Y-, and Z-directions
(II) An adjustment of, based on the mount angles, i.e., the mount roll, yaw, and pitch angles, of the image sensor 40, the actual angles, i.e., actual roll, yaw, and pitch angles, of the image sensor 40 relative to the lens module 30 to the respective typical optimum angles, i.e., typical optimum roll, yaw, and pitch angles

Because the above configuration of the computer 140 measures the actual X-, Y-, and Z-positions of the image sensor 40 on the camera board 50 and the actual roll, yaw, and pitch angles of the image sensor on the camera board 50, the computer 140 makes it possible to adjust, with higher accuracy, (i) the actual X-, Y-, and Z-positions of the image sensor 40 to the respective typical optimum X-, Y-, and Z-positions, and (ii) the actual roll, yaw, and pitch angles of the image sensor 40 to the respective optimum roll, yaw, and pitch angles.

This configuration therefore reduces, during assembling of the camera board 50 to the lens module 30 with the lens module 30 being in focus on the image sensor 40, effort of adjusting arrangement of the camera board 50 required for the lens module 30 to be in focus on the image sensor 40. In particular, the computer 140 measures the mount locations and the mount angles of the image sensor 40 on the camera board 50 during transferring of the camera board 50, making it possible to eliminate the need of setting aside additional time of measuring the mount locations and the mount angles of the image sensor 40. This therefore reduces the total time of completing the focusing adjustment method according to the exemplary embodiment.

The computer 140 causes the image sensor 40 to capture the cross-shaped lights 60 while changing the Z-axis position of the image sensor 40 within the scan region; the scan region is previously defined relative to the optimum positions and optimum angles of the image sensor 40. This therefore enables the size of the scan region as small as possible. That is, if the image sensor 40 were located at any position that faces the lens module 30, the lens module 30 might be out of focus on the image sensor 40, positions of, for example, the peaks or crests of the MTF curves might deviate from each other. For this reason, if the image sensor 40 were located at any position that faces the lens module 30, the size of the scan region might be larger to allow such deviations between the positions of the MTF curves.

In contrast, the actual positions and actual angles of the image sensor 40 according to the exemplary embodiment are adjusted to match the optimum positions and optimum angles of the image sensor 40. For this reason, the lens module 30 is likely to be in focus on the image sensor 40, so that the deviations between the positions of the MTF curves are likely to be smaller. Additionally, the computer 140 of the exemplary embodiment measures, in step S102, the mount locations and the mount angles of the image sensor 40 on the camera board 50, and adjusts the actual positions and actual angles of the camera board 50 in accordance with the measured mount locations and mount angles of the image sensor 40. This results in the deviations between the positions of the MTF curves are likely to be further smaller. For these reasons, the exemplary embodiment enables the size of the scan region to be smaller as compared with a case where the image sensor 40 is located at any position that faces the lens module 30.

Accordingly, the computer 140 of the exemplary embodiment is configured to search for the focusing attitude of the image sensor 40 with respect to the lens module 30 where the lens module 30 is in focus on the image sensor 40 after the actual attitude of the image sensor 40 is closer to the focusing attitude, making it possible to further reduce a time required to identify the focusing attitude of the image sensor 40 with respect to the lens module 30 where the lens module 30 is in focus on the image sensor 40.

The computer 140 causes, in step S104, the image sensor 40 to capture frame images of the cross-shaped lights 60 while continuously moving, without being stopped, the camera board 50 in the scan region. This configuration therefore eliminates, as compared with a case where an image is captured each time movement of the camera board 50 is stopped, the need of establishing, each time movement of the camera board 50 is stopped, a wait time until vibrations of the camera board 50 are sufficiently suppressed, making it possible to reduce a time required to adjust the focus of the camera module 20.

The exemplary embodiment uses the cross-shaped lights 60 as the chart images, and the light exposure time of the image sensor 40 is set to be shorter down to the limit at which the captured chart images can be recognized, resulting in a higher frame rate. That is, the exemplary embodiment enables the movement speed of the camera board 50 to be faster, making it possible to further reduce a time required to adjust the focus of the camera module 20.

In step S104, the scan area 62 is defined such that the lower edge portion 64 and the upper edge portion 65 of the imaging area 63, where no cross-shaped lights 60 are located, are eliminated from the imaging area 63. This results in a higher frame rate. That is, the exemplary embodiment enables the movement speed of the camera board 50 to be faster, making it possible to further reduce a time required to adjust the focus of the camera module 20.

The focusing adjustment method according to the exemplary embodiment predicts the shrinkage distance E100 in the Z direction by which the lens module 30 and the camera board 50 will approach one another during the period from completion of the readjustment process in step S106 to completion of the preliminary curing of the adhesive 70. Then, the focusing adjustment method according to the exemplary embodiment separates, from the lens module 30, the camera board 50 by the predicted shrinkage distance E100 in the Z direction relative to the identified focusing attitude of the camera board 50 where the lens module is in focus on the image sensor 40.

This results in, even if the lens module 30 and the camera board 50 approach one another until the adhesive 70 is temporarily cured, the lens module 30 being in focus on the image sensor 40 with higher accuracy.

The shrinkage distance E100 includes the deviation amount E10 due to the cure shrinkage of the adhesive 70. This offsets location of the camera board 50 more precisely. The focusing adjustment method according to the exemplary embodiment calculates the deviation amount E10 of the adhesive 70 using the coefficient C10 that is previously determined based on the physical properties of the adhesive 70, making it possible to predict the shrinkage distance E100 precisely.

The shrinkage distance E100 includes a camera-module deviation amount due to (i) thermal expansion of the camera module 20 and (ii) shrinkage of the camera module 20 based on heat dissipation. That is, the focusing adjustment method according to the exemplary embodiment predicts the camera-module deviation amount in accordance with (i) an increase in temperature of the camera module 20 during thermal expansion of the camera module 20 and (ii) a coefficient depending on the configuration and physical properties of the camera module 20.

Specifically, the shrinkage distance E100 includes the deviation amount E11 due to (i) thermal expansion of the adhesive 70 and (ii) shrinkage of the adhesive 70 based on heat dissipation. This offsets location of the camera board 50 more precisely. The focusing adjustment method according to the exemplary embodiment calculates the deviation amount E11 of the adhesive 70 based on (i) an increase in temperature of the adhesive 70 induced by laser-beam irradiation thereon and (ii) the coefficient C11 depending on the configuration and physical properties of the adhesive 70, making it possible to predict the shrinkage distance E100 precisely.

The shrinkage distance E100 includes the deviation amount E12 due to (i) thermal expansion of the lens module 30 and (ii) shrinkage of the lens module 30 based on heat dissipation. This offsets location of the camera board 50 more precisely. The focusing adjustment method according to the exemplary embodiment calculates the deviation amount E12 of the lens module 30 based on (i) an increase in temperature of the lens module 30 induced by laser-beam irradiation thereon and (ii) the coefficient C12 depending on the configuration and physical properties of the lens module 30, making it possible to predict the shrinkage distance E100 precisely.

The shrinkage distance E100 includes the deviation amount E13 due to (i) thermal expansion of the camera board 50 and (ii) shrinkage of the camera board 50 based on heat dissipation. This offsets location of the camera board 50 more precisely. The focusing adjustment method according to the exemplary embodiment calculates the deviation amount E13 of the camera board 50 based on (i) an increase in temperature of the camera board 50 induced by laser-beam irradiation thereon and (ii) the coefficient C13 depending on the configuration and physical properties of the camera board 50, making it possible to predict the shrinkage distance E100 precisely.

The shrinkage distance E100 includes the deviation amount E14 caused by heat warpage of the camera board 50, making it possible to offset location of the camera board 50 more precisely.

At least part of the focusing adjustment method according to the exemplary embodiment can be modified. The following describes modifications of the focusing adjustment method according to the exemplary embodiment.

The focusing adjustment method according to the exemplary embodiment analyzes the captured image data of the chart images to accordingly identify the focusing attitude of the image sensor 40 with respect to the lens module 30 where the lens module 30 is in focus on the image sensor 40, and thereafter adjusts, again, the actual positions and actual angles of the camera board 50 in accordance with the identified focusing attitude of the camera board 50 (see steps S104 to S106). The present disclosure is however not limited to the above method according to the exemplary embodiment. Specifically, the focusing adjustment method according to the present disclosure can eliminate the above operations in steps S104 to S106 as long as the accuracy of focusing of the lens module 30 on the image sensor 40 arranged at the optimum positions and the optimum angles satisfies a required focusing accuracy.

While the illustrative embodiment of the present disclosure has been described herein, the present disclosure is not limited to the embodiment described herein, but includes any and all embodiments having modifications, omissions, combinations (e.g., of aspects across various embodiments), adaptations and/or alternations as would be appreciated by those having ordinary skill in the art based on the present disclosure. The limitations in the claims are to be interpreted broadly based on the language employed in the claims and not limited to examples described in the present specification or during the prosecution of the application, which examples are to be construed as non-exclusive.

1. A focusing adjustment method of a camera module that includes an optical system, an image sensor, and a camera board on which the image sensor is mounted, the focusing adjustment method comprising the steps of:
thermally curing, after (i) a position and an angle of the camera board with respect to the optical system is adjusted to match an actual attitude of the image sensor with a focusing attitude of the image sensor with respect to the optical system where the optical system is in focus on the image sensor and (ii) the camera board and the lens module are mounted on one another through an adhesive therebetween, the adhesive to accordingly secure the camera board to the optical system;
predicting, between adjustment of the position and the angle of the camera board and completion of securing of the camera board to the optical system, a shrinkage deviation amount by which the optical system and the camera board will approach one another, the shrinkage deviation amount including a camera-module deviation amount due to (i) thermal expansion of the camera module and (ii) shrinkage of the camera module based on heat dissipation; and
adjusting the position and the angle of the camera board to separate, by the predicted shrinkage deviation amount, the camera board from the optical system as compared with the focusing attitude of the image sensor with respect to the optical system to accordingly offset the predicted shrinkage deviation amount.

2. The focusing adjustment method according to claim 1, wherein:
the step of predicting predicts the camera-module deviation amount in accordance with (i) an increase in temperature of the camera module during thermal expansion of the camera module and (ii) a coefficient depending on a configuration and a physical property of the camera module.

3. The focusing adjustment method according to claim 1, wherein:
the camera-module deviation amount includes:
a first deviation amount due to (i) thermal expansion of the adhesive and (ii) shrinkage of the adhesive based on heat dissipation;
a second deviation amount due to (i) thermal expansion of the camera board and (ii) shrinkage of the camera board based on heat dissipation; and
a third deviation amount due to (i) thermal expansion of the optical system and (ii) shrinkage of the optical system based on heat dissipation.

4. The focusing adjustment method according to claim 1, wherein:
the step of predicting predicts, as a component of the shrinkage deviation amount, a heat-warpage deviation amount of the camera board caused by heat warpage of the camera board.

5. The focusing adjustment method according to claim 1, wherein:
the step of predicting predicts values of the shrinkage deviation amount in respective plural positions; and
the adjusting step adjusts the position and the angle of the camera board to separate, for each of the plural positions, the camera board from the optical system by a corresponding one of distances different from one another to accordingly offset a corresponding one of the predicted values of the shrinkage deviation amount in respective plural positions.

6. The focusing adjustment method according to claim 1, wherein:
the step of predicting predicts, as a component of the shrinkage deviation amount, a deviation amount due to cure shrinkage of the adhesive in accordance with (i) a separation distance between an adhered surface of the optical system and an adhered surface of the camera board and (ii) a coefficient based on a physical property of the adhesive.

7. A focusing adjustment method of a camera module that includes an optical system, an image sensor, and a camera board on which the image sensor is mounted, the focusing adjustment method comprising the steps of:
thermally curing, after (i) a position and an angle of the camera board with respect to the optical system is adjusted to match an actual attitude of the image sensor with a focusing attitude of the image sensor with respect to the optical system where the optical system is in focus on the image sensor and (ii) the camera board and the lens module are mounted on one another through an adhesive therebetween, the adhesive to accordingly secure the camera board to the optical system;
predicting, between adjustment of the position and the angle of the camera board and completion of securing of the camera board to the optical system, a shrinkage deviation amount by which the optical system and the camera board will approach one another, the shrinkage deviation amount including a heat-warpage deviation amount of the camera board caused by heat warpage of the camera board; and
adjusting the position and the angle of the camera board to separate, by the predicted shrinkage deviation amount, the camera board from the optical system as compared with the focusing attitude of the image sensor with respect to the optical system to accordingly offset the predicted shrinkage deviation amount.

8. The focusing adjustment method according to claim 7, wherein:
the step of predicting predicts, as a component of the shrinkage deviation amount, a deviation amount due to cure shrinkage of the adhesive in accordance with (i) a separation distance between an adhered surface of the optical system and an adhered surface of the camera board and (ii) a coefficient based on a physical property of the adhesive.

9. A focusing adjustment method of a camera module that includes an optical system, an image sensor, and a camera board on which the image sensor is mounted, the focusing adjustment method comprising the steps of:
thermally curing, after (i) a position and an angle of the camera board with respect to the optical system is adjusted to match an actual attitude of the image sensor with a focusing attitude of the image sensor with respect to the optical system where the optical system is in focus on the image sensor and (ii) the camera board and the lens module are mounted on one another through an adhesive therebetween, the adhesive to accordingly secure the camera board to the optical system;
predicting, between adjustment of the position and the angle of the camera board and completion of securing of the camera board to the optical system, values of a shrinkage deviation amount by which the optical system and the camera board will approach one another in respective plural positions; and
adjusting the position and the angle of the camera board to separate, for each of the plural positions, the camera board from the optical system by a corresponding one of distances different from one another to accordingly offset a corresponding one of the predicted values of the shrinkage deviation amount in respective plural positions.

10. The focusing adjustment method according to claim 9, wherein:
the step of predicting predicts, as a component of the shrinkage deviation amount, a deviation amount due to cure shrinkage of the adhesive in accordance with (i) a separation distance between an adhered surface of the optical system and an adhered surface of the camera board and (ii) a coefficient based on a physical property of the adhesive.
